(19) United States
(12) Patent Application Publication
(10) Pub. No.: US 2010/0278541 A1
(43) Pub. Date: Nov. 4, 2010

(54) Optical System for Transfer of Timing Reference

(75) Inventors: Matjaz VIDMAR, Nova Gorica (SI); Leon PAVLOVIC, Ljubljana (SI); Patrik RITOSA, Koper (SI); Jurij TRATNIK, Grosuplje (SI); Bostjan BATAGELJ, Ljubljana (SI)

Correspondence Address: BEEM PATENT LAW FIRM, 53 W. JACKSON BLVD., SUITE 1352, CHICAGO, IL, 60604-3787, US

(73) Assignee: INSTRUMENTATION TECHNOLOGIES D.D., Solkan (SI)

(21) Appl. No.: 12/752,798

(22) Filed: Apr. 1, 2010

(30) Foreign Application Priority Data
Apr. 29, 2009 (SI) SI P-200900127

(51) Int. Cl. H04B 10/00

(52) U.S. Cl. 398/154

(57) ABSTRACT

The present invention relates to an optical system for transfer of timing reference signal and radio frequency synchronisation of multiple events with femtosecond precision on multiple remote locations such as within a particle accelerator, where synchronisation scheme with a low phase jitter and a long term stability is required using standard telecommunications single-mode optical fibre. Said system comprises a transmitter (1), a low jitter oscillator (2) and a receiver (3), said transmitter (1) and said receiver (3) being connected by means of a transmission optical line (4) and a return optical line (5).

### CROSS-REFERENCE TO RELATED APPLICATIONS

This application claims the benefit of priority from Slovenia patent application number SI P-200900127, filed Apr. 29, 2009.

### BACKGROUND OF THE INVENTION

1. Field of the Invention

The present invention refers to an optical system for transfer of timing reference and radio frequency synchronisation of multiple events with femtosecond precision on multiple remote locations such as within a particle accelerator for instance where synchronisation scheme with a low phase jitter and a long term stability is required, comprising a standard telecommunications single-mode optical fibre.

2. Description of the Related Art

All known solutions from this field utilise high quality microwave oscillators with a jitter of as low as a few femtoseconds within the integration interval from 10 Hz to 10 MHz offset from the carrier frequency.

There are also known solutions for the timing and radio frequency synchronisation using interferometric and/or mode locking pulse laser source for the stabilisation of the optical fibre link transferring the reference timing signal. The laser source used therewith operates at 1550 nm wave length. Such a fibre comprises low attenuation, high bandwidth and immunity to electromagnetic interferences. However, said fibre is subjected to changes in phase and group velocity depending on temperature variations and/or is sensitive to mechanical and/or acoustic perturbations.

The first group of known solutions is based on the frequency-offset using a so called Michelson interferometer. The optical source is a highly coherent laser operating in a continuous wave mode. The interferometric method is successful in stabilising the optical phase but not the group velocity. Since the group velocity of the fibre link is important for the radio frequency signal distribution the delay is implicitly calculated by the method of a phase subtraction. However, phase stabilisation is not guaranteed at the start of the operation since information of phase is lost when the device is turned off. At every start-up of the transmission system the phase of the radio frequency signal phase has to be reset.

The second group of known solutions utilises a master mode-locked laser which, when locked to the low jitter microwave oscillator, transfers the clock signal in the form of pulse train to multiple locations via stabilized fibre links. Slave lasers are located at each remote location being locked to the master laser and generating the radio frequency signal. In this case, the timing stability of fibre links is critical since there is no feedback connection. The long-term stability is not obtained.

### SUMMARY OF THE INVENTION

It is the object of the present invention to create an optical system for transfer of timing reference and radio frequency synchronisation of multiple events with femtosecond precision on multiple remote locations like, thus remedying the drawbacks of the know solutions.

### BRIEF DESCRIPTION OF THE DRAWINGS

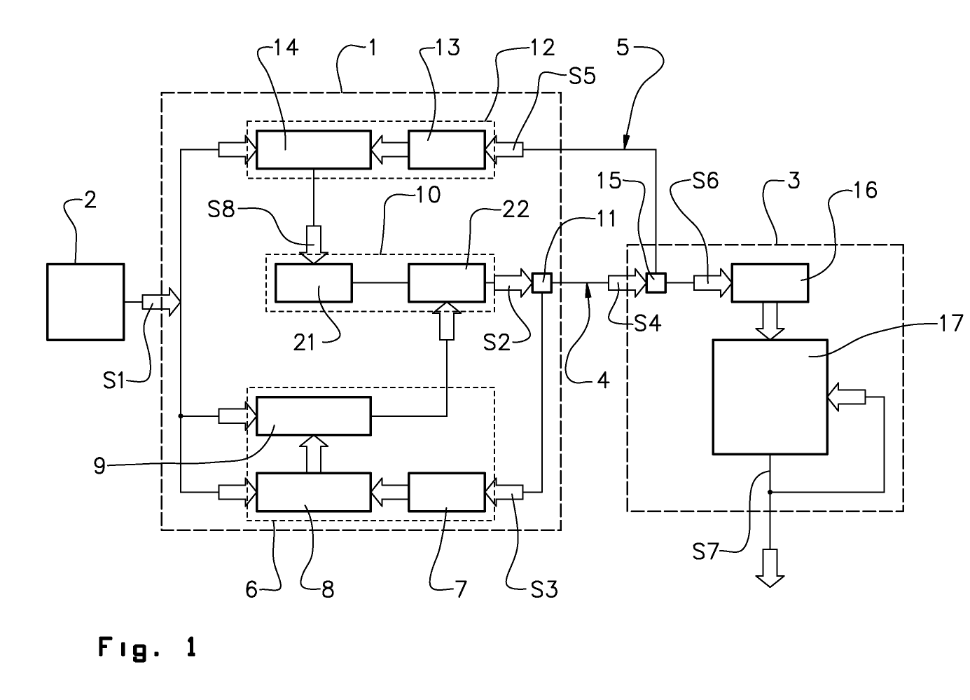

Embodiments of the invention will now be described with reference to at least FIG. 1.

### DETAILED DESCRIPTION OF EMBODIMENTS OF THE INVENTION

According to the invention, the object as set above is solved by stabilizing fibre links which transfer the low jitter microwave signal. With the system for radio frequency synchronisation with femtosecond precision of multiple events at multiple remote locations, like particle accelerators, a stabilized fibre link is utilised according to the invention in order to transfer the low jitter microwave signal. Said fibre link comprises a pair of single-mode optical fibres, thus enabling the compensation of the synchronisation signal phase shift, a transmitter where the phase shift of the demodulated return signal is compared to the input reference and adjusted accordingly by changing the wavelength of the laser source, and a receiver where the first part of the signal is returned to the transmitter and the second part is cleaned by means of a flywheel such as an oscillator operating in phase-locked loop. Here, said laser source is modulated by means of the low jitter microwave signal, and the wavelength of said laser source affects via a chromatic dispersion to the fibre group delay.

The system according to the present invention comprises a transmitter, a low jitter oscillator and a receiver, said receiver and said transmitter being connected with a transmission line and a return line. Said transmission line and said return line are preferably chosen to be a single-mode fibre. Furthermore, it is provided for according to the invention that said transmitter comprises the first unit consisting of the first semiconductor photo diode, a phase detector and a phase shifter, said first unit being connected to a laser electro-optical modulator, and the second unit consisting of the second semiconductor photo diode and a phase detector with a controller.

In addition, it is provided for according to the present invention that said receiver comprises the third semiconductor photo diode and a flywheel. Said flywheel is designed either as a phase-locked loop using an oscillator or as a high quality band-pass filter.

The invention will be described in details hereinafter with references to the embodiment and the accompanying figure which shows a block scheme of an optical system for transfer of timing reference and radio frequency synchronization of multiple events according to the invention.

Said optical system for transfer of timing reference according to the invention comprises a transmitter 1 located at the site of a low jitter oscillator 2, and a receiver 3 located at a remote location, said transmitter 1 and said receiver 3 being connected with a transfer line 4 and a return line 5 which are provided each time in a form of at least one single-mode optical fibre. The use of two optical fibre based lines 4, 5 instead of only one enables the compensation of the phase shift of the synchronization signal. It is assumed that the polarization mode dispersion for both the transmission line 4 and the return line 5 preferably equals or is less than 0.02 ps/√km. The optical fibre based lines 4, 5 are preferably of the same type, exceptionally they may differ in their polarization mode dispersion. When optical fibres of each line 4, 5 are in practise arranged side by side, the external influences are equalized, such as optical fibre elongation due to temperature influence to said optical fibres.

The optical signal source in said transmitter 1 is a generally known laser-modulator block 10, preferably a distributed feedback (DFB) laser source, which is used for very high speed telecommunication connections. Said block 10 can be designed as a single block or, optionally, from a separate laser source 21 and an electro-optical modulator 22.

The transmitter comprises two main units. The first unit 6 comprising the first semiconductor photo diode 7, a phase detector 8 and a phase shifter 9, is connected to the said laser-modulator block 10. The objective of said first unit 6 is to compensate, inside said laser-modulator block 10, the phase deviations of the input (electrical) radio frequency signal 51 being supplied by the low jitter oscillator 2. When a separate laser source 21 and electro-optical modulator 22 are used it is provided for according to the invention that said modulator 22 is a LiNbO3 modulator. Said block 10 emits an optical signal S2, a partial signal S3 diverges at the fibre splitter 11 from said signal S2 and leads to the correction loop comprised of said semiconductor photo diode 7, said phase detector 8 and said phase shifter 9. In this manner the phase mismatch is measured between said input electrical signal S1 from said main oscillator 2 and said optical signal S3 from said splitter 11, and the phase shift is set. Thus, the phase of an output optical signal S4 exiting said splitter 11 is always in-phase with said input electrical signal S1 from said oscillator 2.

The second unit 12 of the transmitter 1 comprising the second semiconductor photo diode 13 and a phase detector with a controller 14 receives an optical signal S5 from said return optical line 5, which splits at the splitter 15 from said output optical signal S4 of said transmitting optical line 4. The phase of said return optical signal S5 is compared to the phase of said input electrical signal S1. Any change of the phase difference is compensated by means of said phase detector with the controller 14 using a return signal S8 which changes the wavelength of said laser source 10. The wavelength of said laser source 10 is used, by means of the chromatic dispersion of each optical fibre which represents the transmission line 4 and return line 5, for setting the group delay of each optical signal S2 and thus, the setting of the group delay of said optical signals S4 and S5 of said optical fibres.

Said partial signal S6 of the input signal S4 travelling from the laser-modulator block 10 and separating from said return optical signal S5 at said splitter 15, is redirected by means of the receiver 3 to the third semiconductor photo diode 16, whereas said return optical signal S5 is sent back via the return line 15 to the second unit 12 of the transmitter 1. The acquired signal S6 is demodulated in the receiver 3 at said mentioned photo diode 16 and amplified to the level that enables phase comparison.

In the particular embodiment, the direct detection of the optical signal S4 is used in the receiver 3 at the remote location. According to the invention, said flywheel 17 is designed either as a phase-locked loop using an oscillator or a high quality band-pass filter.

The signal to noise ratio at the output from the photo diode 16 amounts to approximately 60 dB and is unsuitable for use or for further distribution. Therefore, the output signal from said photo diode 16 is cleaned in said flywheel 17. In order to reduce the phase noise the bandwidth of said loop must be low.

The thermal shift of the semiconductor photo diodes 7, 13, 16 used in the system according to the invention and having preferably the same properties, of the phase detector 8, of the phase detector with the controller 14 and of the flywheel 17 is eliminated by the temperature controlled environment. The transmitter and the receiver are maintained at the same temperature. In this manner, it is ensured that same components respond equally at different locations, both in said transmitter 1 and said receiver 3. Temperature stable chambers lower said thermal shift, thus enabling a long-term stability.

The system according to the invention operates as follows. The optical signal S2 exiting the laser source 10 is split at the splitter 11 into the optical signal S4 directed to the receiver 3 at the remote location, and the optical signal S3 directed to the first semiconductor photo diode 7, where it is converted into an electrical signal. Said electrical signal from said photo diode 7 is directed into the phase detector 8, where the phase of said electrical signal is compared with the phase of the electrical signal S1 exiting the oscillator 2. Afterwards, such a corrective electrical signal exiting said phase detector 8 is directed into the phase shifter 9, where the phase thereof is aligned with the phase of said electrical signal S1 from the oscillator 2. The electrical signal corrected and phase-aligned in a manner as described above is directed further into the laser source 10 where said electrical signal corrects the optical signal 2 exiting said source.

As mentioned above said corrected optical signal S2 is split at the splitter 11 into the optical signal S3 and the optical signal S4, the latter being directed to the remote receiver 3. Said optical signal S4 is split at the splitter 15 into the return optical signal S5 and the optical signal S6. Said return optical signal S5 is directed back to the second semiconductor photo diode 13 of the transmitter 1, where it is converted into an electrical signal and fed into the phase detector with the controller 14, where it is processed and compared with the input electrical signal S1 from the oscillator 2. The corrective electrical signal S8 processed in this manner is directed to the laser source 10, where it sets the laser output wavelength.

Said optical signal S6 exiting the splitter 15 is directed to the third semiconductor photo diode 16 in the receiver 3, where it is converted into an electrical signal. The latter is further guided to said flywheel 17, where it is cleaned of noise and similar interferences. One part of the electrical signal S7 exiting the flywheel 17 is returned to said flywheel in the form of the feedback loop where optionally corrects the phase and amplitude of the exiting electrical signal S7.

1. An optical system for transfer of timing reference and radio frequency synchronisation of multiple events with femtosecond precision on multiple remote locations such as within a particle accelerator, for instance, where synchronisation scheme with a low phase jitter and a long term stability is required, comprising a standard telecommunications single-mode optical fibre, characterized in that it comprises a transmitter (1), a low jitter oscillator (2), and a receiver (3), said transmitter (1) and said receiver (3) being connected by means of a transmitting optical line (4) and a return optical line (5).

2. A system according to claim 1, characterized in that both the said transmitting line (4) and the said return line (5) are formed of at least one single-mode optical fibre.

3. A system according to claim 1, characterized in that said transmitter (1) comprises the first unit (6) consisting of a semiconductor photo diode (7), a phase detector (8) and a phase shifter (9), said unit being connected with the laser-modulator block (10), and the second unit (12) consisting of a semiconductor photo diode (13) and a phase detector with a controller (14).

4. A system according to claim 1, characterized in that said receiver comprises a semiconductor photo diode (16) and a flywheel (17).

5. A system according to claim 4, characterized in that said flywheel (17) is formed as a phase-locked loop using the oscillator.

6. A system according to claim 4, characterized in that said flywheel (17) is formed as a high quality band-pass filter.

7. A system according to claim 2, characterized in that said transmitter (1) comprises the first unit (6) consisting of a semiconductor photo diode (7), a phase detector (8) and a phase shifter (9), said unit being connected with the laser-modulator block (10), and the second unit (12) consisting of a semiconductor photo diode (13) and a phase detector with a controller (14).

8. A system according to claim 2, characterized in that said receiver comprises a semiconductor photo diode (16) and a flywheel (17).
